(19) United States
(12) Patent Application Publication
(10) Pub. No.: US 2005/0132579 A1
(43) Pub. Date: Jun. 23, 2005

(54) Cookie cutter assembly

(76) Inventor: Georganne Sartori, Aurora, CO (US)

Correspondence Address: LEYENDECKER LEMIRE & DALEY, LLC, C/O PORTFOLIO IP P.O BOX 52057, MINNEAPOLIS, MN, 55402, US

(21) Appl. No.: 10/744,455

(22) Filed: Dec. 23, 2003

(51) Int. Cl. B26D 1/00

(52) U.S. Cl. 30/299; 30/301; 30/316

(57) ABSTRACT

A cookie cutter assembly comprising a plurality of cookie cutter dies that are arranged in a substantially planar relationship to each other is described. Preferably, each cookie cutter die has a peripheral shape that defines a character that is different from a character defined by each other cookie cutter die. Further, each of the plurality of cookie cutter dies relate to a common theme, such as a holiday season.

### FIELD OF THE INVENTION

The present invention relates generally to cookie cutters and more particularly to a sheet comprising a plurality of differently shaped cookie cutters thereon to permit a user to cut a plurality of different cookies from a sheet of dough simultaneously.

### BACKGROUND

Individual cookie cutter dies for cutting cookie dough into shapes that are subsequently baked into cookies are well known. A typical cookie cutter die comprises a thin typically vertically orientated periphery and may also include a handle. The periphery of the die corresponds to the desired shape of the resultant cookie. Typically, the cutter is made of a plastic or metal material. Operationally, a user presses the cookie cutter die into a sheet of dough, removes the die, and finally, removes the cut piece of dough from the sheet for baking. This process is repeated with a single cookie cutter die or a plurality of differently shaped cookie cutter dies until there remains no expanses of uncut dough on the sheet larger than any particular die. The left over dough is then either discarded or combined with other dough and rerolled into a new sheet wherein the entire process is repeated.

Cookie cutters are most typically used for certain occasions and at certain times of the year. For instance, it is a tradition in many households to make and decorate a plurality of differently shaped Christmas cookies in the days and weeks leading up to the Christmas holiday. Christmas cookies typically comprise a variety of holiday and winter related shapes such as Christmas trees, snowmen, stockings, Santa Clauses, stars and candy canes. Other occasions to make shaped cookies include Halloween, Easter, Valentine Day and birthdays.

As can be appreciated, a user must have a plurality of separate cookie cutters to make a plurality of differently shaped cookies for any particular occasion. Constantly switching between differently shaped cookie cutters while making cookies can be time consuming. Further, the necessity of spacing each cookie cutter on the dough can also be tedious work. Because of their relatively small size, cookie cutters are typically stored in a kitchen cabinet drawer. A typical cookie cutter user has cookie cutters for several different occasions and accordingly, the cookie cutter collection alone may take up an entire drawer of valuable kitchen storage space, space that could otherwise be better used to store more regularly used kitchen utensils. Finally, when preparing to use a number of cookie cutters for a particular occasion, sorting through all the cutters in a drawer can be frustrating and time consuming.

Cookie cutter assemblies that essentially comprise a plurality of cookie cutter dies arranged in a planar manner are known but they fail to solve the problem of requiring a user to have a plurality of differently shaped cutters when making cookies for a particular occasion or a particular theme. U.S. Pat. No. 5,579,582 discloses a cookie cutter assembly that makes a puzzle and is configured specifically so that the various pieces can be assembled to form a single shape, such as the circle illustrated in the reference. U.S. Patent Application No. 2002/0092180 describes a cookie cutter assembly for simultaneously cutting a plurality of cookies having the same shape, wherein the cutters are arranged in such a manner as to minimize the used dough left on the sheet of dough after the cut cookies are removed. Using this cookie cutter assembly, a user would still have to have different assemblies for each shape he/she desires. Accordingly, this cookie cutter assembly would actually increase a user's storage demands since each assembly is substantially bigger than a single cutter. Cutter die assemblies are also described in U.S. Pat. Nos. 5,063,839 and 4,792,299. Both of these die assemblies are constructed to cut cookies of generally the same shape for use in a commercial cookie making operation. They are not designed for use at home and are not concerned with the fabrication of differently shaped cookies relating to a particular theme or occasion. Concerning the cookie cutter assemblies of U.S. Patent application No. 2002/0,092,180 and U.S. Pat. Nos. 5,063,839 and 4,792,299, none of the described assemblies provide handles or other features that would make the use of the assembly convenient in a household environment.

### SUMMARY OF THE INVENTION

One embodiment of a cookie cutter assembly comprises a plurality of cookie cutter dies including: (1) a first cookie cutter die with a first periphery including a first dough cutting edge wherein the first periphery defines a first character; (2) a second cookie cutter die with a second periphery including a second dough cutting edge wherein the second periphery defines a second character; and (3) a third cookie cutter die with a third periphery including a third dough cutting edge wherein the third periphery defines a third character. The first, second and third dough cutting edges of the assembly are all substantially planar to each other. Finally, the first, second and third characters of the assembly are all different from each other; however, the first, second and third characters are all related to a common theme.

Another embodiment of a cookie cutter assembly comprises a planer sheet that has opposing first and second surfaces. The assembly also comprises a plurality of cookie cutter dies that are arranged on the first surface. Each cookie cutter die of the plurality has a periphery defining a character wherein the character is different from the other characters of the other cookie cutter dies. Finally, the planer sheet and the plurality of cookie cutter dies are integrally formed with each other.

Another embodiment of the present invention comprises a method of making shaped cookies. First, a sheet of dough is placed on a cookie baking sheet, and then a plurality of shaped cookies are simultaneously cut from the sheet of dough using a single cookie cutter assembly while the sheet of dough is on the cookie baking sheet. Next, the excess dough from around the plurality of shaped cookies is removed without moving the shaped cookies, and finally, the shaped cookies are baked.

### BRIEF DESCRIPTION OF THE DRAWINGS

FIG. 1 is an isometric view of a first embodiment cookie cutter assembly according to the present invention.

FIG. 2 is a cross sectional side view taken along line 2-2 of FIG. 1.

FIG. 3 is an isometric view of a second embodiment cookie cutter assembly according to the present invention.

FIG. 4 is a cross sectional side view taken along line 4-4 of FIG. 3.

FIG. 5 is a flow chart illustrating a method of making shaped cookies according to one embodiment of the present invention

### DETAILED DESCRIPTION OF EMBODIMENTS OF THE INVENTION

An assembly of a plurality of differently shaped cookie cutters wherein the cookie cutters relate to a specific occasion, holiday, or topic is described. Advantageously, a user need only have one or two assemblies to make all shapes of cookies for the specific occasion, holiday or topic. Cookies can be produced more quickly as cookies of differing shapes can be cut an entire sheet of rolled dough simultaneously rather than individually. Also, the assembly can be more easily cleaned in a dishwasher rather than cleaning each individual prior art cookie cutter by hand. Additionally, because of the planar size and configuration of the assemblies they need not be stored in a cabinet drawer but rather they can be stored on their sides in a cupboard or in on a closet shelf. Finally, the cost of producing, stocking and selling the assemblies is reduced when compared with selling individual cookie cutters.

In one embodiment, the assembly is integrally formed from a plastic material or pressed from a metal sheet and comprises a planar sheet portion with handle cutouts and 3-12 individual cookie cutter dies perpendicularly extending from one surface of the sheet portion. In another embodiment, the assembly is also integrally formed but various walls and runners connect the individual cookie cutter dies. In yet other embodiment, the cookie cutter dies are separately fabricated from a backing sheet and the dies are bonded or otherwise fastened to the backing sheet.

Definitions

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases means that a particular feature, structure, or characteristic described in connection with the embodiment is included in at least an embodiment of the invention. The appearances of the phrase “in one embodiment” in various places in the specification are not necessarily all referring to the same embodiment.

The phrases “cookie cutter” and “cookie cutter die” are used interchangeably herein and unless otherwise indicated, are synonymous with each other.

The term “character” as used in this specification and claims concerning the shapes of the cookie cutter refers to a representation of a being or a stand-alone object other than a rudimentary or basic shape.

The term “theme” relates to any holiday, occasion, motion picture or any other obvious relationship among a specific group of characters.

### A First Embodiment Cookie Cutter Assembly

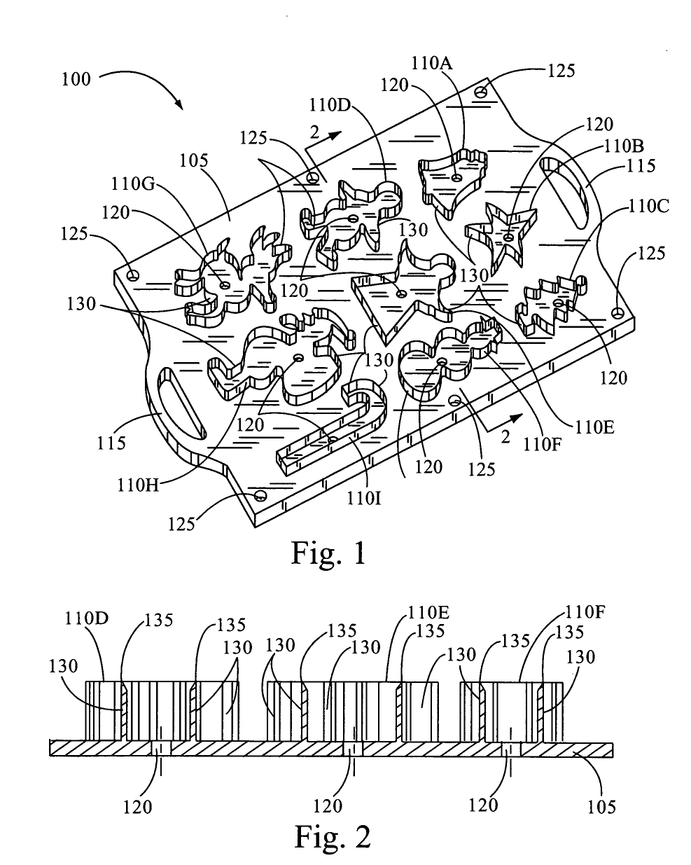

FIGS. 1 and 2 illustrate a first embodiment cookie cutter assembly 100 of the present invention comprising a plate 105 with a plurality of individual cookie cutter dies 110A-I extending from one surface thereof.

The plate 105 is generally rectangular in shape, comprised of plastic and about 0.125″ thick to provide it with sufficient rigidity to maintain a flat planer configuration and hold the cookie cutter dies in the planar configuration. The dimensions of the plate can vary but in one variation of the first embodiment the plate is about 10″ by 15″ to correspond with the typical dimensions of a cookie-baking sheet for reasons discussed below. Although the plate is typically comprised of a plastic material in other variations the plate can be comprised of metal, wood, or composite.

A pair of handles 115 are provided on either end of the plate 105 to assist a user in pressing the assembly against the cookie dough to simultaneously cut the plurality of cookies from the dough. As shown in FIG. 1, the handles are integral with the plate 105. In other variations, however, the handles can be separately produced and attached to the plate. For instance, the handles may be attached to and extend from the surface of the plate parallel and opposite to the surface from which the plurality of cookie cutter dies extend. In yet other variations, the no handles are provided and the user simply grabs the edges of the plate when cutting the cookies.

One or more storage holes 125 are provided through the plate 105 proximate the plate's periphery to provide a convenient means to hang the cookie cutter assembly from a storage hook. Additionally, a number of vent holes 120 are provided in the plate with at least one provided within the periphery of each cookie cutter die 110A-I. The vent holes permit the equalization of air pressure between the air contained in the space between the sheet and the dough of each die and ambient air during the cookie cutting operation. The vent holes may comprise relatively small circular bores as shown or they can comprise much larger openings that approximate the shape of the corresponding die.

The cookie cutter dies 110A-I are generally similar in configuration to a typical stand alone cookie cutter comprising thin cookie cutter walls 130 that extend generally perpendicularly about 0.50″ or so from the surface of the plate 105. The walls of each die form a periphery that is representative of a particular character. For instance in FIG. 1, which depicts a Christmas holiday themed cookie cutter assembly, cookie cutter dies representing a Christmas bell 110A, a star 110B, a Christmas tree 110C, a gingerbread boy 110D, an angel 110E, a snowman 110F, a Reindeer 110G, a Santa Claus 110H, and a candy cane 110I are provided.

In certain variations of the first embodiment, the cutter walls of the cookie cutter dies 110A-I are comprised of the same plastic material as the plate 105 as the plate and the dies are integrally formed in a single molding operation. Typically, the walls are 0.050″ to 0.125″ thick, most preferably about 0.094″ thick, and taper to a blunted point at the distal cutting edge 225. For proper operation of the cookie cutter assembly, all of the cutting edges of the assembly are substantially planar with each other such that when a user presses the assembly against a sheet of dough all the dies cut through the dough substantially simultaneously.

In variations of the first embodiment, the cookie dies 110 can comprise separately manufactured pieces that are attached to the plate 105. For instance, the dies can be made of metal and be brazed, bonded, mechanically fastened or welded to a metal plate. In other variations, plastic or metal cookie cutter dies may be mechanically or adhesively attached to a plastic, metal or wood plate. It is to be appreciated that when the cookie cutter dies are comprised of a formed metal, the edges are typically not tapered as the thickness of the metal sheet material used to make the dies is already very thin, generally about 0.010-0.20″ thick.

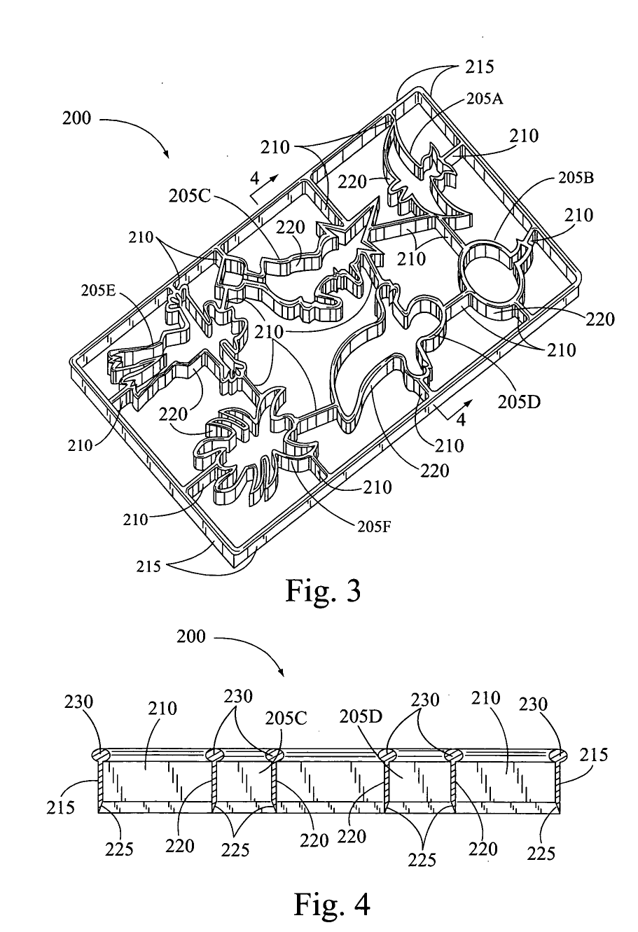

In the preferred embodiments and configurations of the present invention, each cookie cutter die 10 of a particular assembly represents a different character from the other characters represented by the other cookie cutter dies. Additionally, however, each character represented by a particular cookie cutter assembly relates to a common theme with each of the characters of other cookie cutter dies represented on the assembly. For instance, all the characters represented on the exemplary assembly of FIG. 1 relate to the Christmas holiday, and all of the characters represented on the second embodiment assembly of FIG. 3 and discussed below relate to the holiday of Halloween. Advantageously, can make all his/her cookies for a particular occasion using a single cookie cutter assembly rather than having to sort through all his/her cookie cutters, sorting them based on theme and then individually cutting the cookies based from a sheet of dough. Further, because the different character cookie cutter dies are assembled together a equal distribution of each type of cookie is assured.

In one variation of the present invention, the cookie sheet assembly can also include more than cookie cutter die representing a particular character such that the more popular characters ultimately comprise a greater percentage of the cookies made using the sheet. For example, a Christmas sheet assembly may include 9 cookie cutter dies but because the snowman character is more popular with children who typically consume the cookie, the assembly may include 2 snowman cookie cutter dies while the remaining 7 dies all represent different characters.

Themes are not limited to a particular Holiday but may relate to any type of special occasion such as, but not limited to, a birthday, a summer picnic, a fall harvest, a baby shower, a confirmation party and a wedding. The Holiday themes can also include Easter, St. Patrick's Day, Fourth of July, Valentine's Day and others. Other themes can relate to: animals (or particular types of animals such as marine animals), particular movies (such as Nemo or the Loin King), Disney characters, religious symbols, patriotic characters, and particular sporting events.

In the preferred variation of the first embodiment and the second embodiment (discussed below), the entire sheet assembly is integrally fabricated from a plastic material using an injection molding process, although the invention is not necessarily limited to any particular production method. As desired, colored plastic material can be used to provide a finished part in an attractive color. Integrally fabricated plastic cookie cutter assemblies can be formed using any suitable process including vacuum forming, stamping and extruding. Further, the various components can be fabricated individually and joined together in a subsequent manufacturing operation. Cookie cutter assemblies including metal components can also be produced using any suitable method, such as stamping, forging and casting.

### A Second Embodiment Cookie Cutter Assembly

FIGS. 3 and 4 illustrate a second embodiment cookie cutter assembly 200 of the present invention comprising a plurality of individual cookie cutter dies 205A-F and a plurality of runner walls 210 extending between and connecting the various dies. Further, the second embodiment includes a set of peripheral walls 215 that typically form a rectangular exterior of the cookie cutter assembly. The peripheral walls are connected to the cookie cutter dies by additional runner walls. Like the first embodiment, preferred variations of the second embodiment are integrally formed of a plastic material.

The cookie cutter dies are generally similar to the dies of the first embodiment and comprise cutter walls 220 that form a periphery representative of a character and have a tapered cutting edge. Unlike the cutter walls of the first embodiment, however, the top edge of the cutter walls are not joined to a plate but rather are rounded forming a roughly cylindrical rail with a diameter greater than the thickness of the corresponding wall. As with the first embodiment, the cutting edges of all of the various cookie cutter dies are arranged and held in a planar relationship with each other,

The peripheral walls and the runner walls have essentially the same construction as the cutting walls of the cookie dies with tapered cutting edges and generally cylindrical rail top edges. The runner wall span between cookie cutter dies and between the cookie cutter dies and the peripheral walls. Acting in concert with each other the combination of the cutter, peripheral and runner walls all act to form a relatively stiff assembly that effectively holds the cutting edges of all the walls in a planar relationship with each other.

In variations of the second embodiment, the runner and peripheral walls need include cutting edges and accordingly may not have the same height as the cutting walls of the various cookie cutter dies. For example, if the cutter walls have a height of 0.60″, the runner and peripheral walls may have a height of 0.35″ with the blunt bottom edges of the runner and peripheral walls being located vertically about 0.25″ above the cutting edges of the cutter walls. In other variations, the top edges may comprise flanges or other shapes in place of the cylindrical rail. Additionally, handles may be provided for a user to grip during use. Finally, the assembly can be fabricated of metal with the runner walls, peripheral walls and cookie cutter dies being connected via mechanical, adhesive or metallurgical means.

Like the first embodiment, the cutters of the second embodiment all are shaped to represent various characters relating to a specific theme. As represented in FIG. 2, the various dies represent a bat 205A, a pumpkin 205B, a Witch 205C, a ghost 205D, a scarecrow 205E and a spider 205F, which are all Halloween related characters.

In a preferred configuration, the cookie cutter assemblies of either the first or second embodiment design are sold in packages of two or more assemblies, wherein each assembly relates to a different theme. For instance, one package may contain cookie cutter assemblies for a plurality of holidays, such as Christmas, Easter, and Halloween. Accordingly, a potential user can purchase all of the various cookie cutters needed within a household in a single package or in several packages instead of buying larges numbers of individual cookie cutters.

Method of using the Cookie Cutter Assemblies

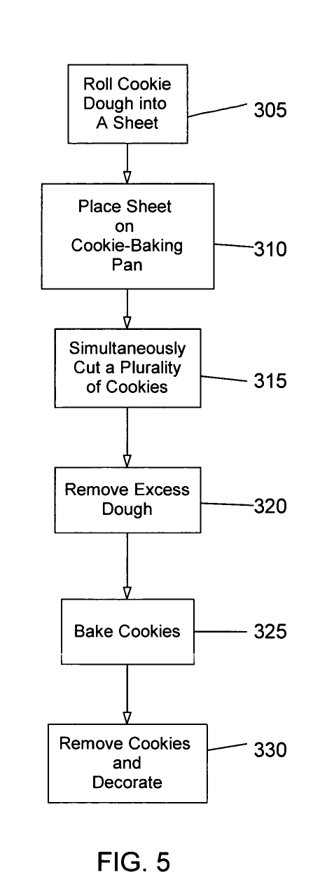

In general, the cookie cutter assembly of the present invention is used is essentially the same manner as an individual cookie cutter with the primary difference being that multiple cookies are cut from a sheet of dough simultaneously, thereby reducing the time necessary to make shaped cookies. However, as mentioned above certain variations of the invention are sized to correspond to the dimensions of a cookie baking sheet, thereby facilitating even more rapid production of shaped cookies. Referring to FIG. 5, a preferred method of making shaped cookies using a cookie cutter assembly is described.

As indicated in block 305, the cookie dough is rolled into a flat sheet roughly the size of a cookie-baking pan. Typical large cookie-baking pans are about 12″ by 16″. Next, the sheet of uncut dough is placed on a properly prepared pan as shown in block 310.

Once the dough is positioned, the user takes the appropriate cookie cutter assembly, positions it over the dough and presses the cutter edges of the various dies into the dough, thereby cutting a plurality of shaped cookies simultaneously as indicated in block 315. The user then removes the excess dough from around the cut shaped cookies as shown in block 320. It is appreciated that since the cut uncooked cookie is never moved once it has been cut. This significantly reduces the chance the cookie will become damaged prior to baking. In contrast, using traditional cookie making methods with single cookie cutters, the cookie is usually cut then moved onto the cookie-baking sheet. It is to be appreciated that such movement can damage uncooked shaped cookies with relatively delicate appendages.

Next as shown in block 325, the cookies are baked. Finally, the cooked shaped cookies are removed from the cookie-baking sheet and decorated as desired.

### Alternative Embodiments

The embodiments of the cookie cutter assembly as illustrated in the accompanying Figures and described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

1. A cookie cutter assembly comprising:
a first cookie cutter die with a first periphery including a first dough cutting edge, the first periphery defining a first character;
a second cookie cutter die with a second periphery including a second dough cutting edge, the second periphery defining a second character;
a third cookie cutter die with a third periphery including a third dough cutting edge, the third periphery defining a third character; and
wherein (1) the first, second and third dough cutting edges are all substantially planar to each other, (2) the first, second and third characters are all different from each other, and (3) the first, second and third characters all relate to a common theme.

2. The cookie cutter assembly of claim 1, wherein the common theme is Christmas.

3. The cookie cutter assembly of claim 2, wherein the first, second and third shapes comprise three of the list of a Christmas tree, a Santa, a stocking, an angel, a candy cane, a bell, a stocking cap, a present with a bow, a reindeer, a star, a snowman, a cross and a gingerbread boy.

4. The cookie cutter assembly of claim 1, wherein the common theme is Halloween and wherein the first, second and third shapes comprise at least one of a witch, a pumpkin, Frankenstein, a vampire, a bat, a goblin, a scarecrow, spider and a ghost.

5. The cookie cutter assembly of claim 1, wherein the common theme is Easter and wherein the first, second and third shapes comprises at least one of the list of a bunny, Easter eggs, a baby chick, a cross, a lamb, a carrot, an Easter basket and an Easter bonnet.

6. The cookie cutter assembly of claim 1, further comprising a planar sheet including first and second surfaces wherein the first, second and third cookie dies are all connected to the first surface.

7. The cookie cutter assembly of claim 6, wherein the sheet includes first second and third vent openings, the first second and third vent openings extending through sheet from the first surface to the second surface, the first, second and third vent openings positioned within the respective first, second and third peripheries.

8. The cookie cutter assembly of claim 6, wherein the sheet further includes one or more holes extending through the sheet generally proximate one or more edges of the sheet.

9. The cookie cutter assembly of claim 6, further comprising one or more handles.

10. The cookie cutter assembly of claim 9, wherein the one or more handles comprises one or more cutouts in the sheet sized to receive at least a portion of a person's hand therethrough.

11. The cookie cutter of claim 1, further comprising runner walls extending between respective cookie cutter dies.

12. The cookie cutter of claim 11, further comprising a periphery of at least one runner wall enclosing the first, second and third cookie cutter dies.

13. A package of comprising two or more cookie cutter assemblies of claim 1, wherein the common theme of at least one of the two or more cookie cutter assemblies is different from the common themes of the others.

14. The package of claim 13, wherein the common theme of at least one of the cookie cutter assemblies is Christmas and the common themes of the other cookie cuter assemblies includes at least one of Easter and Halloween.

15. A method for making cookies, the method comprising:
placing an sheet of dough on a cookie baking sheet;
simultaneously cutting a plurality of shaped cookies from the sheet of dough while the sheet of dough is on the cookie baking sheet using a single cookie cutter assembly;
removing the excess dough from around the plurality of shaped cookies without moving the shaped cookies; and
baking the shaped cookies.

16. The method of claim 15, wherein each of the three or more cookie cutter dies represent different characters.

17. The method of claim 16, wherein each of the three or more cookie cutter dies all relate to a common theme.

18. The method of claim 15, wherein the cookie cutter assembly comprises three or more coupled together cookie cutter dies with cutting edges for each cookie cutter die being substantially planar with cutting edges of the other cookie cutter dies;

19. A cookie cutter assembly comprising:
a planer sheet, the planar sheet having opposing first and second surfaces;
a plurality of cookie cutter dies arranged on the first surface, each cookie cutter dies having a periphery defining a character, the character of each cookie cutter die being different from the other characters of the other cookie cutter dies; and
wherein the planer sheet and the plurality of cookie cutter dies are integrally formed with each other.

20. The cookie cutter assembly of claim 19, wherein the plurality of cookie cutter dies all relate to a common theme.
